(19) United States
(12) Patent Application Publication
(10) Pub. No.: US 2025/0055389 A1
(43) Pub. Date: Feb. 13, 2025

(54) Voorhees Anti-Gravity Engine II

(71) Applicant: Bradley MacDowell Voorhees, Severna Park, MD (US)

(72) Inventor: Bradley MacDowell Voorhees, Severna Park, MD (US)

(21) Appl. No.: 17/990,700

(22) Filed: Aug. 7, 2023

(51) Int. Cl. H02N 11/00; H02K 31/00

(52) U.S. Cl. CPC H02N 11/008; H02K 31/00

(57) ABSTRACT

An anti-gravity field generator comprising, in its preferred form, a plurality of rotating spinners of at least one comprising radially arrayed conducting filaments between two concentric frames of magnetic spokes. The invention generates a harmonically pulsing magnetic field to achieve a resonant loading condition on the Higgs Quantum Field; this anti-gravity field's positronic oscillation achieves resonance with the Higgs Quantum field causing a spontaneous symmetry break with the Higgs Field, which reduces the mass of all the matter within the anti-gravity field.

### CROSS-REFERENCE TO RELATED APPLICATIONS

Voorhees Anti-Gravity Engine 63/360,269.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### STATEMENT REGARDING PRIOR DISCLOSURES BY THE INVENTOR OR A JOINT INVENTOR

The inventor disclosed the basic geometry and design of a “Anti-Gravity Engine” invention on Sep. 13, 2021 to Tom Lipton, California, of the YouTube Channel “OX Tools” who also works at the US Navy Jet Propulsion Laboratory, for assistance with the manufacture of a hydrodynamic bearing to facilitate smooth spinner rotation—who ceased communication after I disclosed the generator design, and Mark Sokol, New Jersey, owner of Falcon Hybrid Solutions to discuss the same on or about Aug. 31, 2021. Who also ceased contact shortly thereafter. However, design elements critical to the function of the anti-gravity generator hadn't been discovered by inventor until months after inventor filed a provisional application on or about Sep. 20, 2021. These incurable defects in the specification, disclosures, and drawing of the original application 63/360,269 application were undiscovered by the inventor until more testing and experimentation had been subsequently performed.

### BACKGROUND OF THE INVENTION

This simple invention merely generates coextensive magnetic fields, a harmonic field (HF) and a static field (SF) that together comprise an Anti-Gravity Field (AGF), when said coextensive HF and SF pass through matter comprised of hexagonal molecular structure. It's conceivable that a HF could create antigravitic forces alone but would be less stable than an AGF comprised of both a SF and a HF. When the coextensive HF and SF are passed through a composition of matter with hexagonal molecular structure, the left-handed chiral electrons (LHe or positrons) in those fields separate from their right-handed (RHe) electron pairs, and oscillate in cyclotron orbits within the SF. The Higgs field, is the quantum field believed to give matter mass, and it is also the quantum field to which the LHe are understood to maintain contact. Contrary to scientific consensus, the inventor believes the vacuum expectation value for the Higgs field is −246 GeV, not +246 GeV. So when the AGF gathers LHe in cyclotron orbits and those LHe are harmonically excited by the HF, the LHe deliver that harmonic excitement energy into the Higgs field; when the LHe are delivering at least +246 GeV into the Higgs field, the Higgs is reduced to the ground state (zero energy) and all the matter inside the AGF must experience a symmetry break with the Higgs field and become massless.

In viewing confirmed footage of UFOs/UAPs in early 2021, the inventor realized that the UFOs/UAPs moved as if they were massless. They accelerated and changed direction in ways that aren't consistent with conventional propulsion and the physics associated with flight.

The inventor studied quantum physics from videos on the internet for several months and chronicled his study in a podcast: Sonic Gravity. As of the filing of the application, this journal is recorded for public access at www.sonic-gravity.us, and during that time, came to the conclusion that the Higgs field, of Quantum Field Theory, behaves like a string and the function of the Higgs String is to anchor matter to the current instance of Planck time that our consciousness is experiencing at any given moment. It is the inventor's belief that the Higgs String is the source of inertial gravity as matter moves in space. The inventor believes that inertial gravity, as defined by Special Relativity and the movement of mass through the curvature of time, is the manifestation of tension in the Higgs Sting between the effect of kinetic time dilation (in which the passage of time varies inversely to velocity—a consensus belief in physics) and the effect of gravitational time dilation (in which the passage of time also varies inversely to gravity—a consensus belief in physics). Therefore, it is an inescapable conclusion that gravity is also a function of a change in velocity (consensus; F=ma) because gravity is a function of mass (consensus), and under Einstein's Equivalence Principle, mass force is equivalent to and indistinguishable from inertial force (a consensus belief), therefore, mass must be a function of velocity because a changing velocity increases force which is indistinguishable from gravity, where gravity is a function of mass, and because under Newton's Law of Gravitation, only constants, mass, and distance determine gravitational force, therefore mass must be a function of velocity for acceleration to cause force which is indistinguishable from gravity under Einstein's Equivalence Principle (not a consensus belief but logically inescapable notwithstanding). The inventor believes this inertial gravity is the manifestation of tension on the Higgs String as said Higgs string exerts a force to keep mass in the same instance of Planck time, while gravitational time dilation and kinetic time dilation simultaneously fight to move the mass forward faster in time, and slower in time respectively. That tension of time, or curvature of time is what the mass experiences as gravity. That tension in the Higgs field as time dilates (faster or slower) is the “G force” that mass experiences as its time dilates and its velocity causes it to shift some of its mass into a dark matter state to observe conservation of mass energy on the hologram. Relativity doesn't assume a “holographic universe,” and to approximate the same dark matter mass shift to a dark matter state, Relativity invented 3 dimensions of momentum and called it “relativistic mass.” So, as velocity increases, instead of recognizing that some mass energy exits the observable universe (off the hologram-which is why photons are massless and when particle velocity is arrested in collisions they blow up and we call them muons and “higher energy” matter), Relativity increases this fantasy momentum to “absorb” energy and account for the loss of mass due to velocity increase that we measure in our detectors. The inventor believes we live in a holographic universe and dark matter is the mass energy that exists “off the hologram” (oscillating in a circle according to SU1 symmetry) leashed to the surface of the hologram [space time] by the Higgs field tension according to SU2 symmetry (not consensus). So when matter achieves luminal speed, it is off the hologram, but still leashed to the surface, so it is observably massless, i.e. dark matter (not consensus but should be becoming obvious), and still has gravity (tension in the Higgs field) and is leashed to space time by the Higgs string, so it still deflects spacetime and causes gravity consistent with General Relativity. Ironically, it is Special Relativity that conflicts with General Relativity, because when Special Relativity accounts for dark matter energy changes (Voorhees Mass Action) with three fantasy dimensions of momentum, the fantasy dimensions of momentum can't model the mechanics and all the consequences of dark matter and Voorhees Mass Action. For instance, these three fantasy dimensions of momentum “relativistic mass” are a math hack to account for the energy of mass that otherwise goes missing as velocity increases, but can't account for the increase of observable mass when objects decelerate past the velocity reference frame of the observer (like in particle collisions) so it's only alternative is to account for the increase of mass in the aftermath of particle collisions by pretending new higher energy particles magically appear in the aftermath of collisions in our particle colliders where the collision residue in the collider out masses the inputs to the collision by two, three, or more orders of magnitude.

General Relativity is Einstein's theory that mass/energy bends spacetime and the deflection in spacetime is gravity. The inventor's Theory of Everything, is that the instance of time to which the Higgs string leashes the matter and energy of the universe, is the 2d holographic surface of our black hole universe at any point in time. Therefore the tension in the Higgs string as it leashes the matter and energy to our instance of time (surface of the black hole that our consciousness recognizes as the immediate present) the tension on the leash, anchored to the holographic surface of the black hole, pulls on the black hole surface, causing a deflection—a dent, just like Einstein told us in GR. The truth of that notwithstanding, the inventor realized that by reducing the energy of the Higgs field to the ground state within an AGF (i.e. canceling that negative energy in the leash by exciting it with positive energy) and if that AGF enveloped a craft within the field, the mass of said craft could be reduced to zero, which would enable flight consistent with the inventor's observation of UFO and UAP footage.

Therefore, the inventor began to believe that the way to achieve mass-less-ness and quantum flight like the UFOs and UAP, was to reduce the Higgs field energy to the ground state so that it could not exert inertial force on, or give, a craft mass.

The LHe trades the Weak Nuclear Force (or a Weak Hyper Charge) back and forth with the Higgs Field which is why photons (Right-Handed electrons) travel unimpeded by the Higgs Field, but because the Higgs Field slows down the speed of the LHe, the inventor believed (according to Newton's 1st law) the LHe slows which means the Higgs Field applies a force to said LHe. And, according to Newton's 3rd law, if the Higgs Field applies a force to the LHe, said LHe also applies a force to the Higgs Field. Since the LHe can apply a force, the inventor began to consider how that force could be applied to deliver energy into the Higgs Field.

The author believes that the only way to decouple the Higgs Field/String from a craft is to harmonically push on the Higgs Field, by pushing on the captured LHe within the SF—that are also attached to the Higgs Field, with a harmonic electromagnetic field at a resonant frequency. Resonance is a loading condition, like pushing someone on a swing, whereby it becomes possible, over time, to build and accumulate energy in a system that will eventually collapse the system. This is achieved by applying a harmonic force at the same impulse frequency as the frequency of vibration of that system (i.e. giving a push to a person on a playground swingset only when they have swung all the way back to the pusher).

The author invented an electromagnetic field generator, that generates an AGF by catching LHe in cyclotron orbits within a SF and harmonically excites them via a coextensive HF, delivering 246 GeV into the LHe and therefore delivering 246 GeV to the Higgs Field, reducing it to the ground state

### (1) Field of the Invention

The field of the invention is electrical generator or motor structure of the magnetic field type; or, alternatively, (310-103) pertaining to the production of electrical and wave energy in a magnetic field (Class 204-155).

### (2) Description of Related Art

Previous attempts by inventors to reduce mass for the purpose of flying space craft (In particular the cited U.S. Pat. No. 10,144,532B2) which to the applicant's knowledge has not actually been demonstrated, seems to focus on complicated equations and hyper technical discussions of vacuum plasma, hyper-cavitation and other complexities, based on lots of complicated technical equations and that doesn't make much sense to the inventor. The previous attempts by other inventors seem to focus electromagnetic field magnitude and complex machinery which has nothing to do with the V.A.G.E. II. The only way to reduce mass is to build enough energy in the Higgs field to cause an asymmetric break by apply a harmonic loading condition to achieve resonance, like pushing a kid on a swing at the exact time the kid swings back to us, to build energy in the Higgs String/Field causing an ever increasing amplitude of positive oscillation until the Higgs String/Field is reduced to the ground state and the matter within the resonant electromagnetic field experiences a spontaneous symmetry break with the Higgs Field and becomes massless.

### REFERENCES

| | | |
|---|---|---|
| US10144532B2 | Dec.4, 2018 | Salvatore, Cezar Pa |
| US10669973B2 | May 2, 2020 | Currie, Andrew |

### BRIEF SUMMARY OF THE INVENTION

This simple invention merely generates coextensive magnetic fields, a harmonic field (HF) and a static field (SF) that together comprise an Anti-Gravity Field (AGF), when said coextensive HF and SF pass through matter comprised of hexagonal molecular structure. When the coextensive HF and SF are passed through a composition of matter with hexagonal molecular structure, the left-handed chiral electrons (LHe or positrons) in those fields separate from their right-handed (RHe) electron pairs, and oscillate in cyclotron orbits within the SF. The Higgs field, is the quantum field believed to give matter mass, and it is also the quantum field to which the LHe are understood to interact. Contrary to scientific consensus, the inventor believes the vacuum expectation value for the Higgs field is −246 GeV, not +246 GeV. So when the SF gathers LHe in cyclotron orbits and those LHe are harmonically excited by the HF, the LHe deliver that harmonic excitement energy into the Higgs field; when the LHe are delivering at least +246 GeV into the Higgs field, the Higgs is reduced to the ground state (zero energy) and all the matter inside the AGF must become massless.

For reasons irrelevant to this application, the inventor hypothesizes that the Higgs Field frequency of vibration is a multiple of 4π (twice the matter to dark matter ratio at the point in space in which the AGF is operating) so a harmonic field impulse frequency that decouples the Higgs Field must be a multiple of twice the matter to dark matter ratio.

### BRIEF DESCRIPTION OF THE DRAWING

N/A.

### DETAILED DESCRIPTION OF THE INVENTION

### (1) Summary of Invention and Advantages

The invention is a anti-gravity field generator that creates an electromagnetic field, harmonically pulsing at a resonant frequency calculated to decouple the Higgs Field from the matter contained within said field, thereby preventing the universe from binding said matter to an instance of time, thereby exempting said matter from passing through the curvature of time, thereby reducing the mass of said matter. The matter within said anti-gravity field thereby achieves a quantum state that can be described as a spontaneous symmetry break with the Higgs Field

The anti-gravity field pulses at a frequency, activating Left Handed electrons, which exert force on the Higgs Field, at a resonant impulse frequency to build enough energy in the Higgs Strings to decouple said Higgs Strings/Field from the matter within said anti-gravity field.

To achieve this state, the invention is comprised of a capacitor, a spinner, ideally a disk or donut of radially arrayed conducting filaments (a filament spinner) which, powered by an electric motor, spins between two locked, radially configured, vertically aligned sets of magnetic spokes (frames). The frame of magnetic spokes may also spin in the opposite direction of the filament spinner to achieve a higher anti-gravity impulse frequency. Like a Faraday wheel generator, where a wheel of conductive material generates an electric current and magnetic field by rotating between two magnets, the claimed invention, the spinning radially arranged filaments, spun between the two frames of magnetic spokes, create a magnetic field impulse when the filament spinner's conducting filaments pass between the magnetic spokes. The magnets in the frames squeeze electrons out of the filament spinner and create electro potential where the outer end of the filament spinner becomes the anode, and the inner end of each filament becomes the cathode. As this electro potential is generated by the filaments' passage through the magnetic spokes, the anti-gravity field pulse is generated when the current is activated as the filaments pass between the magnets in the frame. However, when the filaments pass out from between the magnetic spokes, the anti-gravity field ceases. This cyclic activation and deactivation of the magnetic field (the anti-gravity field) creates the harmonic pulsing that, when resonance is achieved, builds energy in the Higgs string until it decouples it, causing a spontaneous symmetry break with the Higgs Field, for all matter within the anti-gravity field. This induced quantum state reduces the mass of the invention and everything within the anti-gravity field said invention generates.

It's possible, that at a high enough frequency, when the generator components become massless, the friction of the system approaches zero, when this happens, and the anode and cathode contacts completing the circuit between the outer edge of the center spinner, may be able to power the now massless/frictionless motor, and create the first quasi-perpetual motion machine/powerplant. It technically wouldn't be perpetual motion since it harnesses the energy in quantum fluctuations to power itself, the same way an internal combustion engine harnesses the energy in its fuel, but for all intents and purposes, it would appear to behave like a perpetual motion machine and a self-sustaining source of clean energy.

In one form, the filament spinner, spins between to fixed frames of aligned spokes.

In another form, the filament spinner spins between fix frames of aligned spokes, that also spin in the opposite direction.

In another form, the generator includes a switch to transfer the power generated by the filament spinner back into the motor to sustain the rotation of the filament spinner, which tends to spin the filament spinner faster and generate more power as the more powerful field induces a more powerful magnetic field, which further reduces the mass of the invention and further reduces the generator's internal friction, which causes the motor to experience more power, lowering the mass of the invention, spinning the filament spinner faster, creating a more powerful field in perpetuity.

### (2) Description of Preferred Embodiments

The invention is comprised of an electric motor [symbol] , a filament spinner [symbol] , ideally a disk or donut of radially arrayed conducting filaments [symbol] , (within the filament spinner [symbol] ) which, powered by an electric motor [symbol] , is spun on an axle [symbol] that passes through the frames [symbol] without making contact with said frames [symbol] . The spinner [symbol] spins between two locked, radially configured, vertically aligned sets of magnetic spokes [symbol] contained in the frames [symbol] . The two frames [symbol] of the magnetic spokes [symbol] , may also spin in the opposite direction of the filament spinner [symbol] to achieve a higher impulse frequency. It operates similar to a Faraday wheel generator, where a wheel of conductive material generates electricity and a constant electromagnetic field by spinning between two magnets. However, in the claimed invention, the spinning radially arranged filaments [symbol] , spun between the two frames [symbol] of magnetic spokes [symbol] , create a magnetic field impulse when the filament spinner's [symbol] , conducting filaments [symbol] pass between the magnetic spokes [symbol] , of both frames [symbol] . The magnets [symbol] squeeze electrons out of the filament spinner [symbol] and create electro potential where the outer end of the filament spinner [symbol] becomes the cathode, and the inner end of each filament [symbol] becomes the anode. As this electro potential is generated by the filaments' [symbol] passage through the magnetic spokes [symbol] , the electromagnetic field pulse (the anti-gravity field) generated by the intermittent current is activated. However, when the filaments [symbol] pass out from between the magnetic spokes [symbol] , the field abates. This cyclic activation and deactivation of the electromagnetic field creates a harmonic pulsing magnetic field (the anti-gravity field) that, when resonance is achieved, builds energy in the Higgs string until it decouples it, causing a spontaneous symmetry break with the Higgs Field within the harmonically pulsating magnetic (anti-gravity) field. This symmetry break will reduce the mass of the invention and everything within the electromagnetic field it generates.

To achieve the resonant frequency at the lowest possible magnitude and frequency, the spokes of the magnet [symbol] should be arrayed at a distance apart of 4π times the thickness of the magnetic spokes [symbol] .

Graphene, because of its hexagonal molecular structure, is an ideal coating for the magnetic spoke frame as it has been shown to activate Left Handed electrons in the presence of a magnetic field. In order to achieve the requisite density of cyclotron LHe in the antigravity field, it is necessary to pass the magnetic field through an amplifying material composite of layered hexagonal molecular structure composition.

The mechanism for achieving the spontaneous symmetry break is not principally the power of the magnetic field, the key is in the frequency of the pulse, so small magnets [symbol] and filaments [symbol] are effective. The prototype frames [symbol] for the device used fixed magnetic spokes [symbol] were constructed with 1/32″ wide magnet rods [symbol] spaced at ¼″ on center. The prototype filament spinner [symbol] was comprised of a donut with an inner [symbol] diameter of 18″ and an outer [symbol] diameter of 24″, using 30 gage filaments [symbol] spaced at 1/16″ on center. This configuration creates an anti-gravity field pulse frequency of 1.5 MHz when spun at 100,000 RPM.

It's possible, that at a high enough frequency, when the generator components become massless, the friction of the system approaches zero, when this happens, and the anode [symbol] and cathode [symbol] contacts completing the circuit between the outer edge [symbol] of the center spinner [symbol] and the inner edge [symbol] of the center spinner [symbol] , may be able to power the now massless/frictionless motor [symbol] , and create the first quasi-perpetual motion machine/powerplant. Technically, it wouldn't be “true” perpetual motion since it harnesses the energy in quantum fluctuations to power itself, the same way an internal combustion engine harnesses the energy in its fuel, but for all intents and purposes, it would behave like a perpetual motion machine and a self sustaining source of clean energy.

In one form, the filament spinner [symbol] , spins between to fixed frames [symbol] of aligned spokes [symbol] .

In another form, the filament spinner spins between fix frames [symbol] of aligned magnetic spokes [symbol] , that also spin in the opposite direction.

In another form, the generator includes a switch to transfer the power generated by the filament spinner [symbol] back into the motor [symbol] to sustain the rotation of the filament [symbol] spinner [symbol] , which tends to spin the filament [symbol] spinner [symbol] faster and generate more power as the more powerful field induces a more powerful magnetic field, which further reduces the mass of the invention and further reduces the generator's internal friction, which causes the motor [symbol] to experience more power, lowering the mass of the invention, spinning the filament [symbol] spinner [symbol] faster, creating a more powerful field in perpetuity.

In another form, graphene can be used to line the invention to facilitate Left Handed electron creation and help sustain operation at higher temperatures.

In another form, the filament [symbol] spinner [symbol] can be fitted with conducting rings at the outer [symbol] and inner edge [symbol] of the spinner so that the inner contact point [symbol] and outer contact point [symbol] have a greater surface area over which to keep the circuit closed during operation at high RPM. Additionally, magnets the device could be arrayed around the perimeter of the filament spinner's outer ring [symbol] for stability and to prevent the filament spinner from making contact with the magnet frames [symbol] at high RPM.

### SEQUENCE LISTING

Not Applicable.

I claim:

1. A mass reduction device comprising:
a Faraday disk-like spinner;
field amplifying matter consisting of hexagonal molecular layer composition;
a motor rotating said spinner to create a harmonic electromagnetic (antigravity) field that reduces the mass of matter within said harmonic electromagnetic field.

2. The device of claim 1 wherein the spinner comprises a plurality of coextensive Faraday disk like spinners with at least one solid surface and at least one coextensive spoked spinner and magnet frame for mechanical signal modulation.

3. The device of claim 1 wherein the spinner comprises a plurality of coextensive Faraday disk like spinners with at least one solid surface spinner wired for external electrical signal modulation.

4. The device of claim 1 wherein the spinner comprises a plurality of coextensive Faraday disk-like spinners with at least one coextensive spoked spinner and magnet frame for mechanical signal modulation and at least one spinner wired for signal external electrical signal modulation.

5. The device of claim 1 wherein the motor is fitted with a switch to channel the voltage generated by the spinner back into said motor.

6. The device of claim 1 wherein the spinner is lined with graphene.

7. The device of claim 1 wherein any spinner is a hoop.

8. The device of claim 1 wherein the field amplifying matter comprises graphene, bismuth, magnesium, zinc, and/or nickel.

9. A plurality of the devices of claim 1 wherein the orientation of the devices project overlapping antigravity fields to completely envelop a volume of interior space.
